(19) United States
(12) Patent Application Publication
(10) Pub. No.: US 2020/0247442 A1
(43) Pub. Date: Aug. 6, 2020

(54) CARGO CARRIER SYSTEM AND CARGO TRANSPORTATION SYSTEM

(71) Applicant: Sergio Izzo, Arlington, TX (US)

(72) Inventor: Sergio Izzo, Arlington, TX (US)

(21) Appl. No.: 16/779,561

(22) Filed: Jan. 31, 2020

Related U.S. Application Data
(60) Provisional application No. 62/799,319, filed on Jan. 31, 2019.

(51) Int. Cl. B62B 1/20; B62B 5/06; G06Q 30/06

(52) U.S. Cl. CPC B62B 1/208; B62B 2202/52; G06Q 30/0645; B62B 5/064

(57) ABSTRACT

A cargo carrier system includes a frame supporting a flexible body forming an interior area, the frame having a handle; and one or more legs pivotally secured to the handle; the one or more legs to support the frame in a first position; and the one or more legs are to pivot such that the handle supports the frame in a second orientation, the second orientation to provide a chair; one or more wheels supported by the frame.

### BACKGROUND

### 1. Field of the Invention

The present invention relates generally to cargo carrier systems, such as wheelbarrows and wagons, and more specifically, to a cargo carrier system with a carrier that can include a plurality of accessories, thereby allowing for the carrier to have multiple uses. The system of the present invention is specifically well adapted for use on a beach but could be adapted for a variety of other uses.

### 2. Description of Related Art

Cargo transportation systems are well known in the art and are effective means to transport items from one location to another. Such systems include wagons, wheelbarrows, and the like. For example, FIG. 1 depicts a conventional wagon 101 having a carrier body 103 attached to wheels 105 and a handle 107. During use, cargo is placed in the wagon and transported from one location to another.

One of the problems commonly associated with system 101, as well as other wheelbarrows and wagons, is limited use. For example, wagon 101 is difficult and cumbersome to pull on a beach, as the wheels will become stuck, and the carrier may not be suitable to transport all items and may become heavy.

Accordingly, although great strides have been made in the area of cargo carrier systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is an isometric view of a common wagon;

FIG. 2 is an isometric view of a cargo carrier system in accordance with a first embodiment of the present application;

FIG. 3 is an isometric view of the system of FIG. 2 in a second configuration in accordance with the present application;

FIG. 4 is an isometric view of the system of FIG. 2 in a folded configuration in accordance with the present application;

FIG. 5 is an isometric view of a cargo carrier system in accordance with an alternative embodiment of the present application;

FIG. 6 is a close up view of a release of FIGS. 2 and 5 in accordance with the present application;

FIG. 7 is an isometric view of a hinge system in accordance with the present application;

FIG. 8 is a close up view of the hinge system of FIG. 7; and

FIG. 9 is a schematic of a cargo transportation system with the cargo carrier system of FIG. 2 incorporated in accordance with the present application.

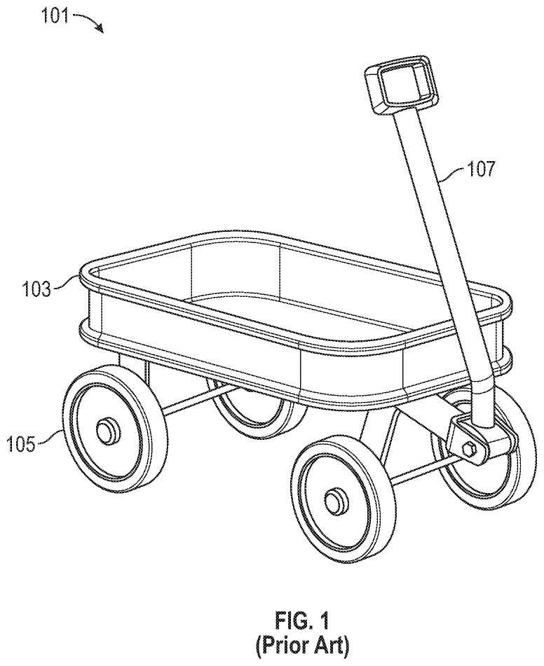

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional cargo transportation systems. Specifically, the present invention provides for a system that includes a cargo carrier, similar to a wheelbarrow, that is adaptable specifically for use on a beach, but can easily be modified for other purposes, that includes one or more accessories and accessory attachments that allow for improved convenience for the user. In addition, the system provides for a seat cushion built into These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

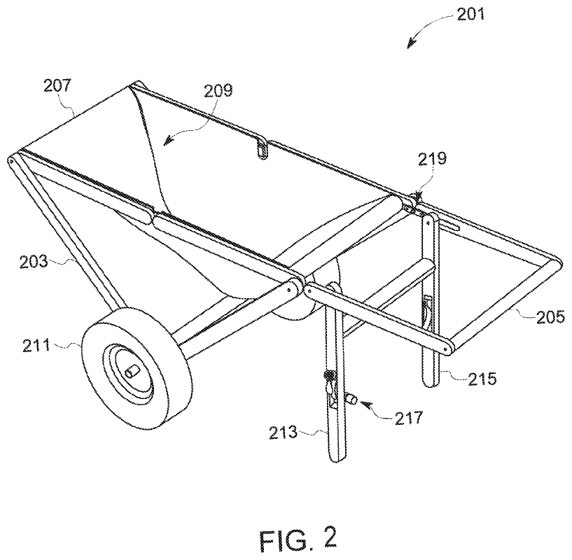

Referring now to the drawings wherein like reference characters identify corresponding or similar elements throughout the several views, FIG. 2 depicts a side view of a cargo carrier system 201 in accordance with a preferred embodiment of the present application. It will be appreciated that system 201 overcomes one or more of the above-listed problems commonly associated with conventional cargo transportation systems, such as conventional wheelbarrows or wagons.

In the contemplated embodiment, system 201 includes cargo carrier having a frame 203 with a handle 205. The handle 205 is configured to fold into a compact position for easy transportation, as will be discussed herein. The carrier further includes a flexible body 207 forming an interior area 209 to receive cargo for transportation and for forming a chair configuration, as shown in FIG. 2. The system further includes one or more wheels 211 secured to the frame and configured to transport the system over sand on a beach. In the preferred embodiment, the wheels are lightweight dual beach tires that are easy to navigate through sand. The cargo frame 203 can vary in shape, size, and materials.

System 201 further includes legs 213, 215 pivotally attached to the frame via hinge systems 219 as will be discussed herein. In the preferred embodiment, the system further includes a cooler carrier 217 that is configured to receive and hold a cooler for easy transport.

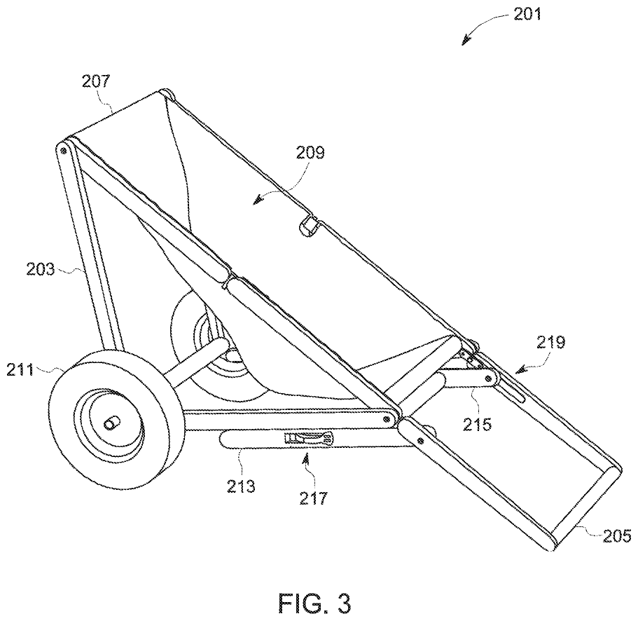

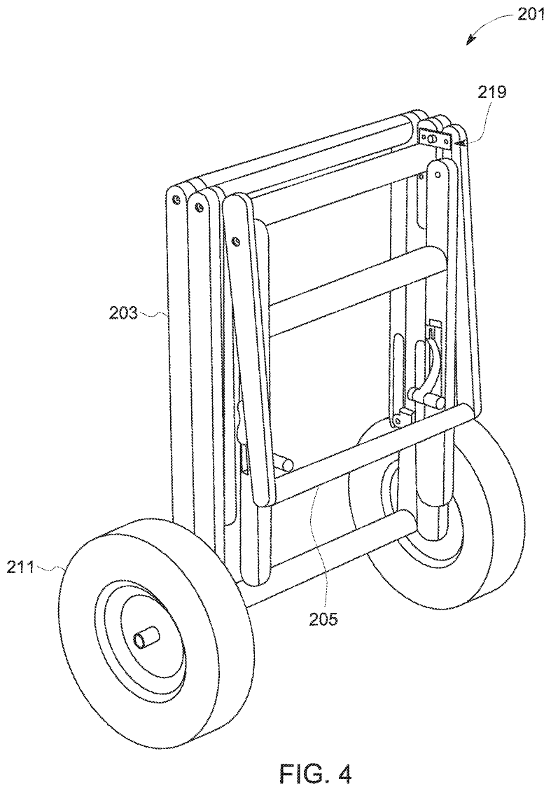

As shown with FIGS. 2, 3, and 4, the system is configured to have a first orientation (shown in FIG. 2) in which the system is used to transport items on the beach. The system includes a second orientation (shown in FIG. 3) that forms a chair, wherein the frame is supported by the handle 205 resting on the ground surface and the flexible body 207 forming the chair for use by the user. The system includes a third orientation (shown in FIG. 4), wherein the frame is in a folded position, that allows for easy storage, such as in a vehicle.

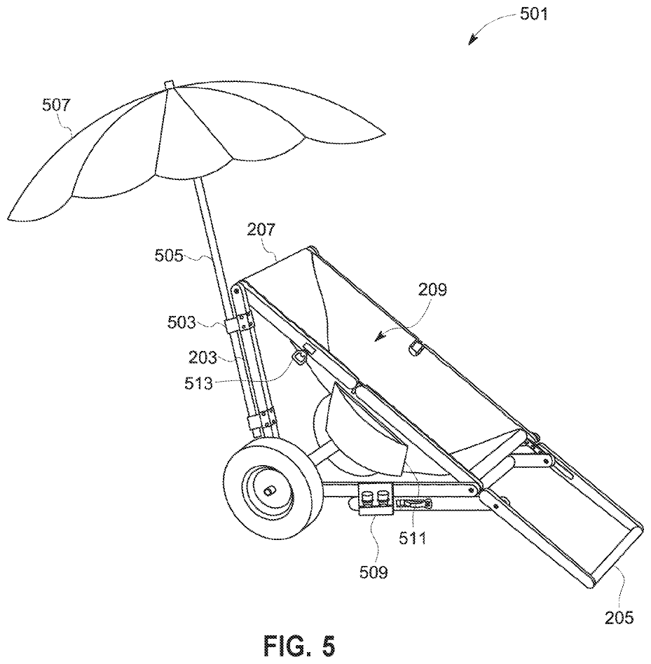

In FIG. 5, an alternative embodiment of a cargo carrier system 501 is shown. System 501 includes some or all of the features discussed above, but further includes one or more accessories. As shown, it is contemplated that the system can include an umbrella holder 503 that can be in the form of a bracket or the like secured to the frame and configured to receive the umbrella pole 505 to support the umbrella 507 above the cargo carrier. This feature provides shade above the user as the user sits in the chair configuration. Another accessory contemplated is a cup holder 509 secured to the frame 203. The cup holder 509 can vary in attachment means and location as aesthetical, manufacturing, or functional considerations require. The system can also include one or more storage compartments 511, which can be pouches/pockets secured on the interior or exterior of flexible body 207. The system can also include a bottle opener 513 secured to the frame 203 at one or more positions. It should be appreciated that the various accessories can vary in size, position, attachment means, and the like as desired by the user.

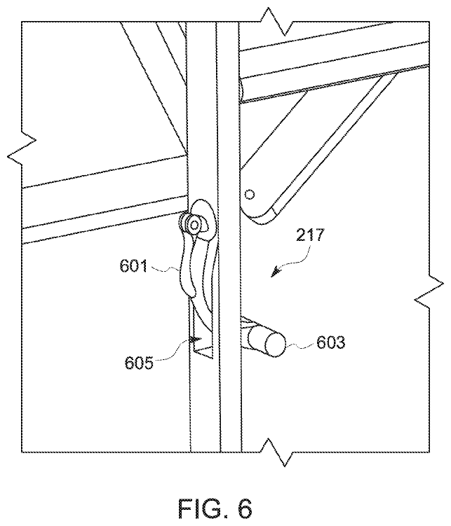

In FIG. 6, the cooler holder 217 is shown in detail, which includes a handle 603 that pivots within a channel 605 and is secured in place via a locking device 601. The handles are positioned on either side of the frame such that a cooler is positioned between the two handles and the handles are tightened and locked in place to hold the cooler in place.

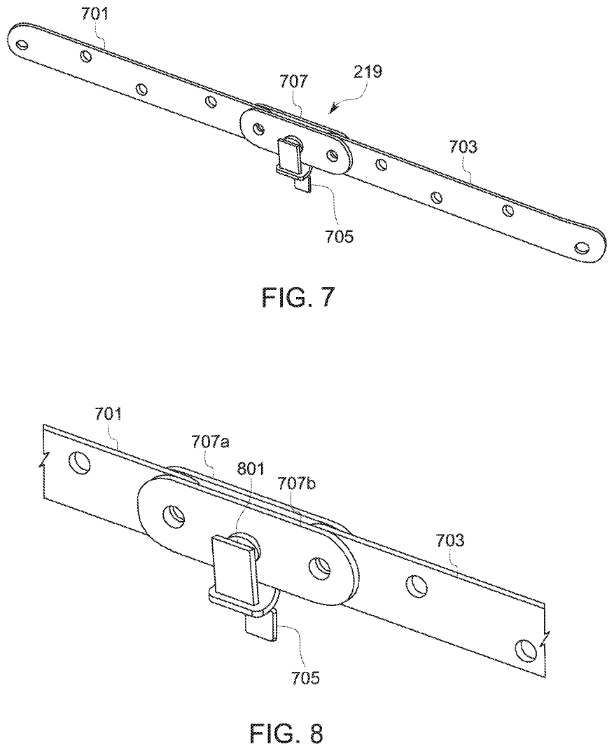

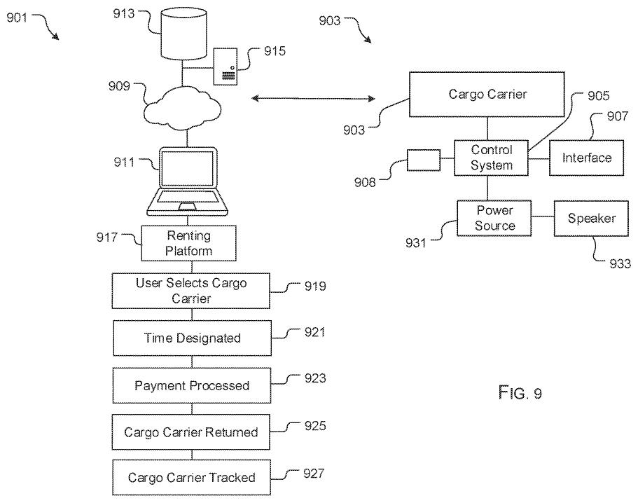

In FIGS. 7 and 8, hinge system 219 is shown. Hinge system 219 includes a first arm 701 and a second arm 703 pivotally engaged with a channel 707, such that the arms 701, 703 are released to pivot via a release button 705 and a protrusion. It should be appreciated that the user can release and lock the hinge together via the release 705.

It should be appreciated that one of the unique features believed characteristic of the present application is the customization of the system that allows for the user to add one or more accessories as desired.

In FIG. 9, a simplified schematic of a cargo transportation system 901 is shown. System 901 includes a cargo carrier system 903 that includes some or all of the features discussed above, and further includes a control system 905 that can include a user interface 907. The control system 905 is configured to communicate with a network 909 via a communication chip 908, the network 909 having one or more of a computer 911, a database 913, and a server 915. In this embodiment, a platform 917 is used to rent out the cargo carrier system. The platform provides a means for the user work through any of the following, including selecting a cargo carrier, designating a time, making a payment, and returning the carrier, as shown with boxes 919, 921, 923, 925. It is contemplated that the carrier can also be tracked as desired 927. This system provides a means for the cargo carrier systems to be rented out to users, such as for a short-term use on the beach or the like.

It should be appreciated that the cargo carrier system 903 could further include a power source 931 and other electronical accessories, such as speakers 933 and the like. The features of each system discussed above can be interchanged as desired.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A cargo carrier system, comprising:
a frame supporting a flexible body forming an interior area, the frame having:
a handle; and
one or more legs pivotally secured to the handle;
wherein the one or more legs are configured to support the frame in a first position; and
wherein the one or more legs are configured to pivot such that the handle supports the frame in a second orientation, the second orientation configured to provide a chair;
one or more wheels supported by the frame.

2. The system of claim 1, wherein the handle is secured to the frame by a hinge system, the hinge system having a first arm attached to the handle, a second arm connected to a portion of the frame, and a release configured to release the first arm relative to the second arm such that the handle is allowed to pivot.

3. The system of claim 1, further comprising:
a cooler holding system having one or more handles extending inward from the one or more legs and configured to receive a cooler.

4. The system of claim 3, wherein the one or more handles is engaged with a locking device to secure the one or more handles in an extended position.

5. The system of claim 1, further comprising:
a cup holder secured to the frame.

6. The system of claim 1, further comprising:
a storage compartment secured to the interior area.

7. The system of claim 1, further comprising:
an umbrella holder secured to the frame.

8. A cargo transportation system, comprising:
a cargo carrier system having:
a frame supporting a flexible body forming an interior area, the frame having:
a handle; and
one or more legs pivotally secured to the handle;
wherein the one or more legs are configured to support the frame in a first position; and
wherein the one or more legs are configured to pivot such that the handle supports the frame in a second orientation, the second orientation configured to provide a chair;
one or more wheels supported by the frame; and
a control system;
a network with a computing device configured to communicate with the control system;
a platform accessible via the computing device;
wherein the platform is configured to accept payment for a predetermined time period for a rental of the cargo carrier system through the computing device.
